(19) United States
(12) Patent Application Publication
(10) Pub. No.: US 2006/0190255 A1
(43) Pub. Date: Aug. 24, 2006

(54) Speech recognition method

(75) Inventor: Toshiaki Fukada, Yokohama-shi (JP)

Correspondence Address: Canon U.S.A. Inc.;Intellectual Property Division, 15975 Alton Parkway, Irvine, CA, 92618-3131, US

(73) Assignee: Canon Kabushiki Kaisha, Tokyo (JP)

(21) Appl. No.: 11/352,661

(22) Filed: Feb. 13, 2006

(30) Foreign Application Priority Data
Feb. 22, 2005 (JP) 2005-045618

(51) Int. Cl. G10L 15/04

(52) U.S. Cl. 704/251

(57) ABSTRACT

A speech recognition apparatus is configured to correct an output recognition result in continuous speech recognition using a physical button (key) to specify the position of a correct portion or an incorrect portion, so that the recognition result can be corrected with simple operation, for visually-impaired users, users who cannot use vision, or in cases where the user is using an apparatus that does not have a display unit.

### BACKGROUND OF THE INVENTION

1. Field of the Invention

The present invention relates to a method for implementing correction of speech recognition results with a simple operation.

2. Description of the Related Art

One of the significant problems for putting continuous speech recognition into practical use is the difficulty of correction of misrecognition. For example, the use of continuous speech input enables the setting of a plurality of commands in operating an apparatus. However, if two commands such as “A, B” are spoken and an incorrect recognition result such as “C, B” or “A, B, C” is obtained, how to specify the incorrect portion C and to re-utter or delete this portion becomes a problem. Such error correction is especially cumbersome for visually-impaired users, users that cannot use vision, or users using an apparatus that does not have a display unit.

In view of the above problem, various methods of correcting speech recognition results with a simple operation have been disclosed. In Japanese Patent Application Laid-Open No. 11-338493, a correction button separate from an input button is provided for determining whether an utterance is intended for correction of the past utterance or for new speech to be recognized. In this method, the position to be corrected is specified by an apparatus and not by a user, so that a portion to be corrected could be misidentified. Additionally, a method of inputting a correction command by voice instead of using a correction button is disclosed (as in “wrong, meeting” in which “wrong” is the correction command) . However, the correction command itself could be misrecognized.

Furthermore, Japanese Patent Application Laid-Open No. 2000-259178 discusses a method in which recognition results are individually displayed for respective recognition units, and, for example, with an “F5” key pressed, correction candidates, or N-best alternatives, for the fifth recognition unit are displayed. However, this method only addresses a substitution error as a recognition error and cannot correct insertion and deletion errors. Additionally, as the recognition result is selected from correction candidates that are displayed, or the candidates are read out by voice, from which the correct recognition is specified, the method is not easy to use for visually-impaired users.

Moreover, Japanese Patent Application Laid-Open No. 2004-93698 discusses a method in which different codes or numbers are assigned to each letter in the Japanese hiragana letter string of the recognition result displayed on a screen, and the user specifies a code and utters correction words to replace an error. However, this method also only addresses a substitution error as a recognition error and cannot correct insertion and deletion errors. Additionally, since the correction unit is one letter, correction of words will be time-consuming and is, therefore, not user-friendly. Furthermore, since a display device is used to provide the recognition result to the user, visually-impaired users cannot conduct an operation to correct recognition errors.

### SUMMARY OF THE INVENTION

The present invention is directed to a method of correcting speech recognition results with a simple operation which can be easily used by all types of users including visually-impaired users, users that cannot use vision, and users using an apparatus that does not have a display unit. In the method, a user uses a physical button (key) to specify the position of misrecognition in an output result of continuous speech recognition. As a result of continuous speech recognition, deletion and insertion errors may be easily corrected in addition to substitution errors. Therefore, the present invention is also directed to a method of correcting all of such types of errors with unified operability.

According to one aspect of the present invention, a speech recognition method includes a receiving step of receiving speech information, a speech recognition step of recognizing the speech information received in the receiving step to obtain a recognition result, an outputting step of outputting the recognition result obtained in the speech recognition step, and a correcting step of correcting the recognition result output by the outputting step based on re-speak received after accepting a specification of a correct portion in the recognition result via at least one physical key.

According to another aspect of the present invention, a speech recognition method includes a receiving step of receiving speech information, a speech recognition step of recognizing the speech information received in the receiving step to obtain a recognition result, an outputting step of outputting the recognition result obtained in the speech recognition step, and a correcting step of correcting the recognition result output by the outputting step based on re-speak received after accepting a specification of an incorrect portion in the recognition result via at least one physical key.

According to a further aspect of the present invention, a speech recognition method includes a receiving step of receiving speech information, a speech recognition step of recognizing the speech information received in the receiving step to obtain a recognition result, an outputting step of outputting the recognition result obtained in the speech recognition step, and a correcting step of correcting the recognition result output by the outputting step based on re-speak received after accepting a specification of whether the recognition result is correct or incorrect via at least one physical key.

According to a further aspect of the present invention, a speech recognition method includes a receiving step of receiving speech information, a speech recognition step of recognizing the speech information received in the receiving step to obtain a recognition result, an outputting step of outputting the recognition result obtained in the speech recognition step, and a correcting step of correcting the recognition result output by the outputting step based on re-speak received after accepting a specification of an incorrect portion and a type of error in the recognition result via at least one physical key.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram of an exemplary hardware configuration of an information apparatus using a speech recognition result correction method according to an embodiment of the present invention.

FIG. 2 is a block diagram showing an exemplary module configuration for the speech recognition result correction method according to the embodiment.

FIG. 3 shows combinations of correct and incorrect results obtained for input voice commands and output recognized commands in a case where up to two commands can simultaneously be recognized with respect to one utterance.

FIG. 4 is an example of a physical key used to correct a recognition result.

FIG. 5 is a diagram showing examples of operations of pressing the physical key in specifying a correct portion in a recognition result with respect to the combinations shown in FIG. 3.

FIG. 6 is a flowchart of the process of a speech recognition result correction method in which a correct portion of the recognition result is specified.

FIG. 7 is a diagram showing examples of operations of pressing the physical key in specifying an incorrect portion in a recognition result with respect to the combinations shown in FIG. 3.

FIG. 8 is a flowchart showing the process of a speech recognition result correction method in which an incorrect portion of the recognition result is specified.

FIG. 9 is a diagram showing examples of operations of pressing the physical key in specifying whether a recognition result is correct or incorrect with respect to the combinations shown in FIG. 3.

FIG. 10 is a flowchart showing the process of a speech recognition result correction method in which it is specified whether a recognition result is correct or incorrect.

FIG. 11 is a flowchart showing the process of a speech recognition result correction method in which it is sequentially specified whether a recognition result in each recognition unit is correct or incorrect.

FIG. 12 is a diagram showing examples of operations of pressing the physical key in specifying an incorrect portion and a type of error in the recognition result with respect to the combinations shown in FIG. 3.

FIG. 13 is a flowchart showing the process of a speech recognition result correction method in which an incorrect portion and a type of error in the recognition result are specified.

FIG. 14 is a diagram showing combinations of correct and incorrect results obtained for input voice commands and output recognized commands in a case where up to three commands can simultaneously be recognized with respect to one utterance.

FIG. 15 is a diagram showing examples of operations of pressing the physical key in specifying a correct portion in a recognition result with respect to the combinations shown in FIG. 14.

FIG. 16 is a diagram showing examples of operations of pressing the physical key in specifying an incorrect portion in a recognition result with respect to the combinations shown in FIG. 14.

FIG. 17 is a diagram showing examples of operations of pressing the physical key in specifying whether a recognition result is correct or incorrect with respect to the combinations shown in FIG. 14.

FIG. 18 is a diagram showing examples of operations of pressing the physical key in specifying an incorrect portion and a type of error in the recognition result with respect to the combinations shown in FIG. 14.

### DETAILED DESCRIPTION OF THE EMBODIMENTS

Exemplary embodiments of the invention will be described in detail below with reference to the drawings.

### First Embodiment

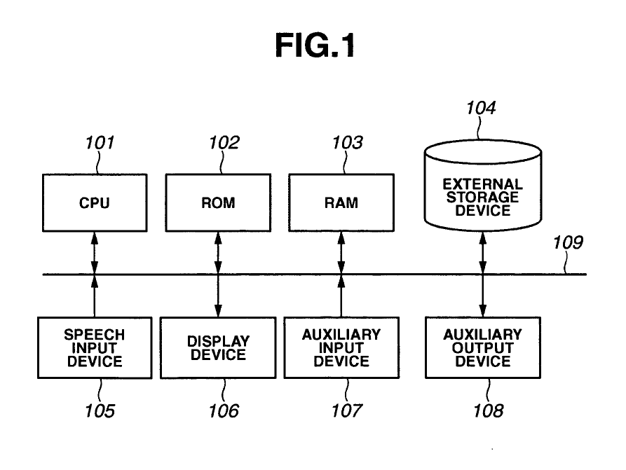

FIG. 1 is a block diagram showing an exemplary configuration of a speech recognition apparatus according to a first embodiment of the present invention. A central processing unit (CPU) 101 conducts various control operations in the speech recognition apparatus of the embodiment in accordance with a control program stored in a read-only memory (ROM) 102 or a control program loaded from an external storage device 104 into a random access memory (RAM) 103. The ROM 102 stores various parameters as well as control programs to be executed by the CPU 101. The RAM 103 provides a work area when the CPU 101 conducts the various control operations, as well as stores control programs to be executed by the CPU 101. An external storage device 104 includes, for example, a hard disk, a floppy disk, a compact disk-ROM (CD-ROM), a digital versatile disk-ROM (DVD-ROM), a memory card, or some combination thereof. In a case where the external storage device 104 is a hard disk, various programs installed from a CD-ROM or floppy disk are stored therein. A speech input device 105 includes, for example, a microphone. Speech recognition is performed for speech input to the speech input device 105. A display device 106 includes, for example, a cathode ray tube (CRT) or a liquid crystal display (LCD). The display device 106 displays items associated with setting and inputting of processing contents. An auxiliary input device 107 includes, for example, a button, a numeric keypad, a keyboard, a mouse, or a pen. An instruction to begin inputting a user's voice is generated using the auxiliary input device 107. An auxiliary output device 108 includes, for example, a speaker. The auxiliary output device 108 is used to confirm a speech recognition result by voice. A bus 109 is used to connect (facilitate communication among) all of the above devices.

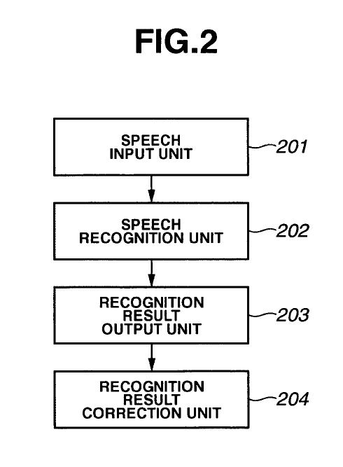

FIG. 2 is a block diagram showing an exemplary module configuration for a speech recognition result correction method. A speech input unit 201 receives a speech signal from the speech input device 105. A speech recognition unit 202 recognizes speech input in the speech input unit 201. The speech recognition unit 202 analyzes the speech input, calculates the distance to a reference pattern, and conducts the search process. A recognition result output unit 203 outputs a result recognized by the speech recognition unit 202 to the display device 106 and/or the auxiliary output device 108 for the user. A recognition result correction unit 204 allows the auxiliary input device 107 to specify a correct portion in the recognition result output by the recognition result output unit 203, and then allows the speech input device 105 to input a re-speak (accept a corrected speech input) for the misrecognition of the speech.

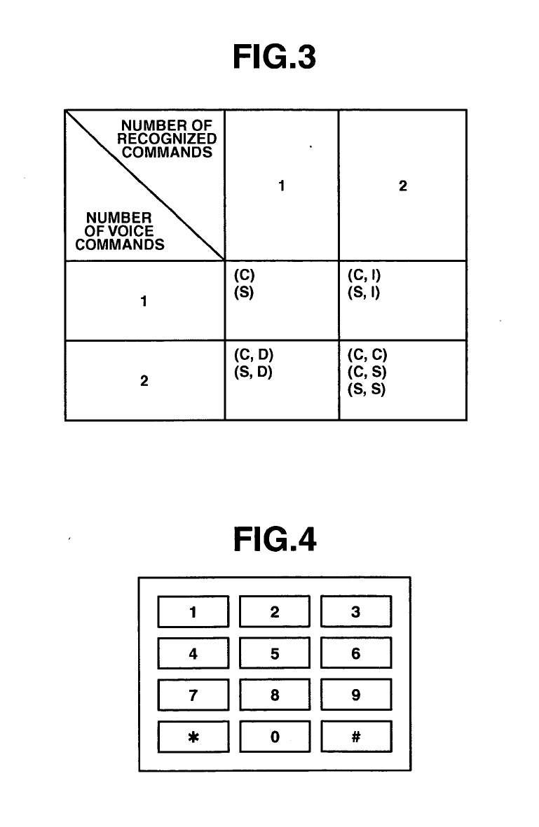

FIG. 3 is a diagram showing combinations of correct and incorrect results obtained for input voice commands and output recognized commands in a case where up to two commands can simultaneously be recognized with respect to one utterance. In FIG. 3, C stands for a correct portion, S stands for a substitution error, D stands for a deletion error, and I stands for an insertion error. For example, (C, S). indicates that two recognition results are output by the recognition result output unit 203, one of which is correct, and the other is a substitution error. In this instance, whether the first command is correct or the second command is correct is not distinguished.

At this point, a task in which a copying machine is operated by voice commands is considered as an example. The vocabulary to be recognized is commands related to the output paper size that include “A4”, “A3”, “B4”, and “B5”, and commands related to the number of copies that include “1 copy” to “100 copies”. Additionally, it is assumed that up to two commands (either one command or two commands) can be recognized simultaneously. Furthermore, it is assumed that the commands can be given in any order. In this case, examples of the utterances are “A4, 5 copies”, “80 copies, B5”, “4 copies”, and “A3”. It can be appreciated that in a case where the output paper size or the number of copies is not input, default values such as “auto” for the paper size and “1 copy” for the number of copies are set. In this case, if the speech input is “A4, 5 copies” (wherein the number of voice commands is two), and the recognition result is “A4, 15 copies” (wherein the number of recognized commands is two), there is a substitution error in which “5 copies” has been misrecognized as “15 copies”. This case corresponds to the correct-incorrect result pattern (C, S) in FIG. 3. Similarly, in a case where the speech input is “A4, 15 copies” (wherein the number of voice commands is two), and the recognition result obtained is “A4” (wherein the number of recognized commands is one), there is a deletion error in which “15 copies” has not been recognized. This case corresponds to the correct-incorrect result pattern (C, D) in FIG. 3. Furthermore, in a case where the speech input is “A4” (wherein the number of voice commands is one), and the recognition result obtained is “A4, 4 copies” (wherein the number of recognized commands is two), there is an insertion error in which “4 copies” has been recognized in excess. This case corresponds to the correct-incorrect result pattern (C, I) in FIG. 3. In the present embodiment, the user can confirm a correct portion by specifying the correct portion using a physical key for all combinations shown in FIG. 3. FIG. 4 illustrates an example of such a physical key, which includes a common numeric keypad.

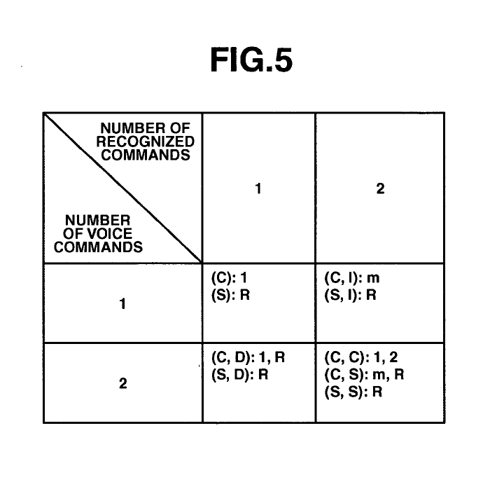

FIG. 5 is a diagram showing examples of operations of pressing the physical key in specifying a correct portion in a recognition result with respect to the combinations shown in FIG. 3. “(C):1” indicates that both the number of voice commands and the number of recognized commands are one, and in a case where the result is correct, numeric key “1” is pressed. The definition of “1” is that the first (1^{st}) recognized command output as a recognition result is correct. Similarly, “(C, C):1, 2” indicates that both the number of voice commands and the number of recognized commands are two, and in a case where two commands are correct, or the “first (1^{st})” and “second (2^{nd})” recognized commands are correct, numeric keys “1” and “2” are pressed.

Additionally, “(C, I): m” is an example in which the recognition result for the voice command “A4” (wherein the number of voice commands is one) is “A4, 4 copies” (wherein the number of recognized commands is two) . In this example, as the “first (1^{st})” recognized command is correct, numeric key “1” is pressed (m=1). It will be appreciated that if “4 copies, A4” is obtained as a recognition result, then the “second (2^{nd})” recognized command is correct, so that numeric key “2” is pressed (m=2). In this way, m takes the value of either 1 or 2.

Furthermore, “(S):R” is a case where both the number of voice commands and the number of recognized commands are one, and a misrecognition (S) has occurred. In this case, as there is no correct recognition, there is no specification of the correct portion, and a re-speak R for re-uttering the misrecognized portion by voice is conducted. In a case where a re-speak is to be conducted, the utterance can be made after pressing a button or can begin without pressing a button. Similarly, as “(S, D):R”, “(S, I):R”, “(S, S):R” do not have any correct recognition portion, specification of the correct portion is not made, and a re-speak R for re-uttering the misrecognized portion by voice is conducted.

Moreover, “(C, S): m, R” is an example in which a recognition result “A4, 15 copies” (wherein the number of recognized commands is two) has been obtained for the voice command “A4, 5 copies” (wherein the number of voice commands is two). In this example, as the “first (^{st}) recognized command is correct, numeric key “1” is pressed (m=1), and then, re-speak R is conducted. It will be appreciated that if “B4, 5 copies” has been obtained as a recognition result, the “second (2^{nd})” recognized command is correct. Accordingly, numeric key “2” is pressed (m=2), and then re-speak R is conducted. In this way, m takes the value of either 1 or 2.

Additionally, “(C, D):1, R” corresponds to an example in which a recognition result “A4” (wherein the number of recognized commands is one) is obtained for the voice command “A4, 15 copies” (wherein the number of voice commands is two) In this example, as the “first (1^{st})” recognized command is correct, numeric key “1” is pressed, and then, re-speak R is conducted.

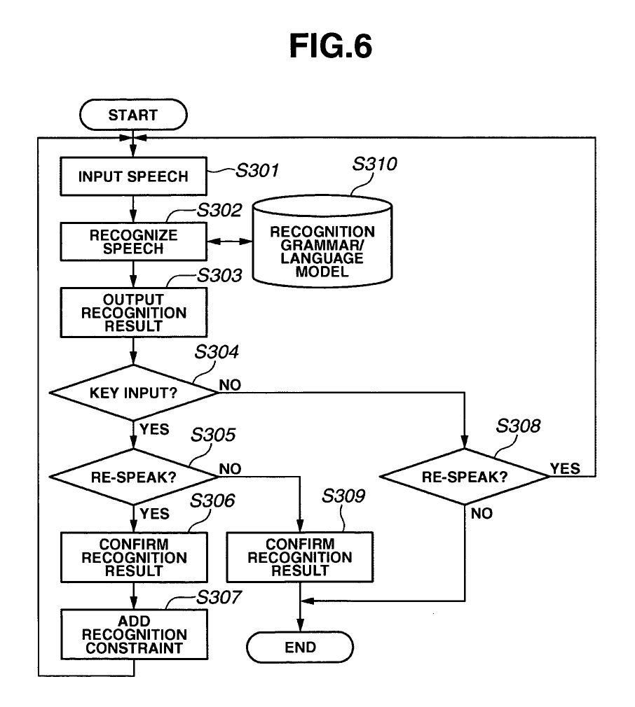

FIG. 6 is a flowchart showing the process of a speech recognition result correction method in which a correct portion in a recognition result is specified. First, speech is input in step S301. Next, in step S302, speech input in step S301 is analyzed, and feature parameters of the speech are obtained. Then, a search process is conducted based on a recognition grammar/language model S310. An acoustic model or a pronunciation dictionary (not shown) can also be used. In step S303, a result recognized in step S302 is presented to the user. Examples of how the result is presented include displaying the result on the display device 106 and/or audibly outputting the result, e.g., by speech output employing a speaker as the auxiliary output device 108. Speech output can be realized by speech synthesis of the character information (such as transcription or readings) of the recognition result. In this case, for the user to accurately specify which one of the recognized results is a correct portion, the unit of recognition must be accurately presented to the user. More particularly, for example, in a case where the result is “A4, 4 copies”, “A4” is presented as the first recognized command, and “4 copies” is presented as the second recognized command. In a case where the result is to be displayed, methods such as inserting separators like “,” to clarify the separation between the units of recognition, or placing one unit of recognition per one box (rectangular window) can be employed. Additionally, in a case where speech is output, an auditory signal marking the separation can be inserted. Examples of auditory signals are a silent pause to be inserted between units of recognition, an annunciation sound such as a “blip”, or reading out the number of the unit such as “1. (one) A4, 2. (two) 4 copies” by voice. By informing the user of the unit of recognition using such a method, the user can accurately be informed that, for example, in a case where the command for setting the zooming ratio is “A4 to B5”, either “A4” and “B5” are separate, or “A4 to B5” is one command.

Next, in step S304, it is determined whether the key input for specifying a correct portion is entered. In a case where the key input is entered, or in the cases of(C), (C, I), (C, D), (C, C), and (C, S), it is determined in step S305 whether re-speak is conducted. In a case where there is re-speak, that is, in the case of (C, D) or (C, S), the recognition result of the correct portion is confirmed in step S306. In the case of (C, D), it can be understood that the user has input 2 commands, one of which has been correctly recognized and the other has not been output as a recognition result. Similarly, in the case of (C, S), it can be understood that the user has input two commands, one of which has been correctly recognized and the other has been misrecognized. That is, in these cases, it can be expected that one command will be uttered in the re-speak. Additionally, for example, if the number of copies is correct, it can be expected that the re-speak will be related to the paper size. Consequently, in these cases, it is unnecessary to recognize continuous speech up to two commands during recognition of re-speak. Only one command related to the output paper size should be recognized. That is, it is possible to add a constraint in performing the recognition of re-speak. Step S307 is a process for placing such a recognition constraint. To be more precise, in recognizing the speech of re-speak, a constraint is placed on the recognition grammar/language model S310. The process then returns to step S301. Alternatively, it is also possible to conduct a process in which only the result among the speech recognition result of the re-speak satisfying the constraint is output in step S303. It will be appreciated that whether or not the key input is entered or whether or not the re-speak is conducted can be determined using a timer to determine whether there is such an event input within a certain length of time. In a case where it is determined in step S305 that re-speak is not be conducted, that is, in the cases of (C), (C, I), and (C, C) (or in cases where time has run out in (C, D) or (C, S)), as a correct portion has already been confirmed, the correct portion is confirmed instep S309. The process then ends.

Alternatively, if there is no key input in step S304, it is determined in step S308 whether re-speak is conducted. In a case where it is determined that re-speak is not conducted (which does not correspond to any of the cases in FIG. 5), the process ends without any confirmation. Additionally, in a case where re-speak is conducted in step S308, that is, in the cases of (S), (S, I), (S, D), and (S, S), as no correct portion has been confirmed, a recognition constraint cannot be placed as in step S307. The process then returns directly to step S301.

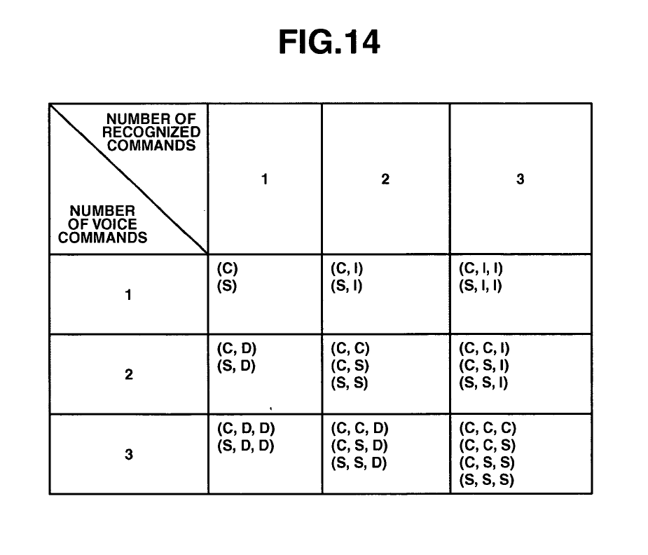

In the embodiment described above, all combinations of correct and incorrect results in cases where up to two commands can simultaneously be recognized with respect to one utterance have been described. However, the present invention is not restricted to this embodiment and can be applied to a given number of commands. FIG. 14 is a diagram showing all of combinations of correct and incorrect results obtained for input voice commands and output recognized commands in a case where up to three commands can simultaneously be recognized with respect to one utterance. In FIG. 14, C, S, D, and I are the same as those in FIG. 5. In FIG. 14, for example, (C, S, I) represents that three recognition results have been output with respect to two speech input commands, one of which is correct, and the other two are incorrect (one of which is a substitution error and the other is an insertion error) . As in the case of FIG. 5, these notations indicate only the combination and the order cannot be distinguished.

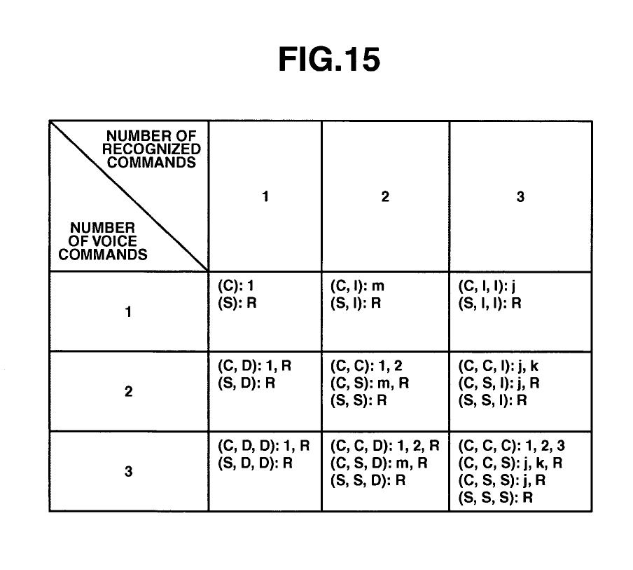

FIG. 15 is a diagram showing examples of operations of pressing the physical key in specifying a correct portion in a recognition result with respect to the combinations shown in FIG. 14. As the section in which a pair of (the number of voice commands, the number of recognized command) is (1, 1), (1, 2), (2, 1), and (2, 2) is the same as in FIG. 5, explanation on this section will be omitted. Additionally, although the rest of the pairs are also the same as in the case of FIG. 5, j and k in FIG. 15 take the values of 1 to 3, and j and k take different values (j!=k) . For example, (C, I, I) is a case where the number of voice commands is one and the number of recognized commands is three, and the voice command is correct. In this case, as one of the three output results is correct, numeric key “1” (j=1) is pressed when the “first” command is correct, numeric key “2” (j=2) when the “second” command is correct, and numeric key “3” (j=3) when the “third” command is correct. As seen, j takes one of the values between 1 and 3. Additionally, (C, C, S) is a case where, when the numbers of voice commands and recognized commands are three, two of the results are correct and one is a substitution error. In this case, as two among the first to third outputs are correct, numeric keys j and k (j, k={1, 2, 3}, j!=k) corresponding to the two outputs are pressed.

With a configuration as described above, a method of correcting misrecognition in a continuous speech recognition by easy and unified operations can be provided. This will enable speech recognition apparatuses that can be put into practical use for visually-impaired users, users that cannot use vision, or for users using an apparatus that does not have a display unit.

### Second Embodiment

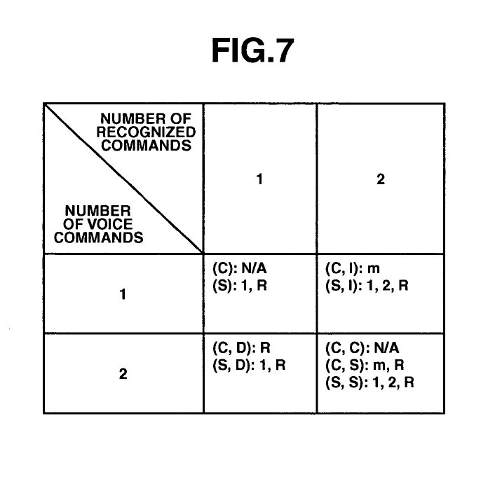

In the above first embodiment, a correct portion in a recognition result is specified for the combinations shown in FIG. 3 or FIG. 14. However, an incorrect portion can also be specified. FIG. 7 is a diagram showing examples of operations of pressing the physical key in specifying an incorrect portion in a recognition result with respect to the combinations shown in FIG. 3. In FIG. 7, N/A indicates that the results are all correct without any misrecognition so that there is no need to specify an incorrect portion. The other combinations are the same as those in FIG. 5, except that an incorrect portion is to be specified.

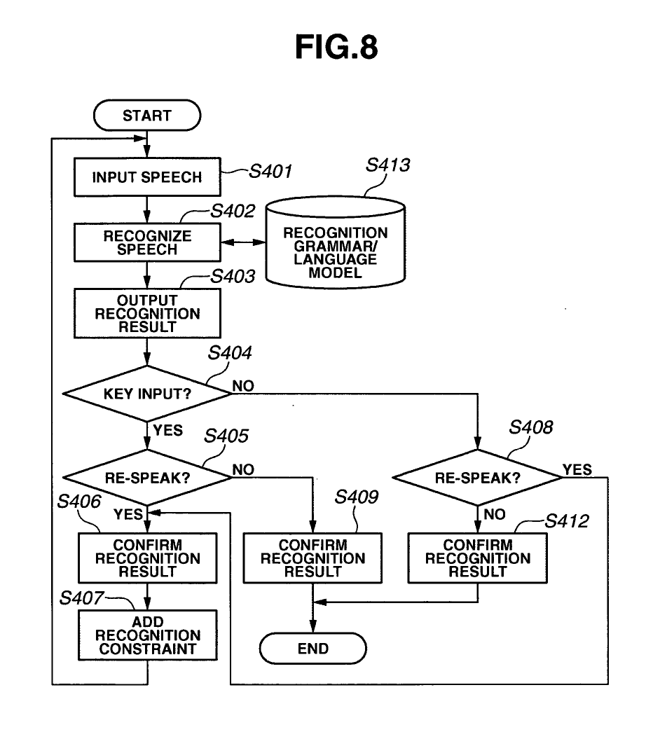

FIG. 8 is a flowchart showing the process of a speech recognition result correction method in which an incorrect portion in a recognition result is specified. In FIG. 8, as steps S401 to S403 are the same as steps S301 to S303, and a recognition grammar/language model S413 is the same as the recognition grammar/language model S310, explanation on these steps will not be repeated here. In step S404, it is determined whether the key input for specifying an incorrect portion is entered. In a case where there is the key input, or, in the cases of (S), (C, I), (S, I), (S, D), (C, S), and (S, S), it is determined in step S405 whether re-speak is conducted. In a case where re-speak is conducted, that is, in the cases of (S), (S, D), (S, I), (C, S), and (S, S), in step S406, the recognition result is confirmed for the cases where a correct portion can be confirmed, or for C in (C, S). The confirmation process is not conducted for the other cases. In FIG. 8, in the case of (C, S), it can be understood that the user has input two commands, one of which has been correctly recognized and the other has resulted in a substitution error. Therefore, it can be expected that one command will be spoken in the re-speak in this case. As a result, a constraint can be placed when conducting speech recognition of the re-speak as in step S307 of the first embodiment.

Step S407 is a process for placing a recognition constraint as described above. To be more precise, in recognizing the speech of the re-speak, a constraint is placed on the recognition grammar/language model S413. The process then returns to step S401. Alternatively, it is also possible to conduct a process in which only the result among the speech recognition result of the re-speak satisfying the constraint is output in step S403. If a constraint cannot be placed, then the recognition constraint addition process is not conducted. It will be appreciated that the determination as to whether the key input is entered or the re-speak is conducted should be made as in the first embodiment. In a case where it is determined in step S405 that re-speak is not be conducted, or, in the case of (C, I) (or in a case where time has run out in (S), (S, D), (S, I), (C, S), and (S, S)), a correct portion is confirmed in step S409 for those in which the correct portion can be confirmed. The process then ends.

In a case where there is no key input in step S404, it is determined in step S408 whether re-speak is conducted. If it is determined that re-speak is not conducted, or in the case of (C) and (C, C), the recognition result is confirmed to be correct in step S412. The process then ends.

In a case where re-speak is conducted in step S408, or in the case of (C, D), the recognition result is confirmed to be correct in step S406, and a recognition constraint is added in step S407. The process then returns to step S401.

In the second embodiment, all combinations of correct and incorrect results in a case where up to two commands can simultaneously be recognized with respect to one utterance have been described. As in the first embodiment, it is also possible to apply the embodiment to a given number of commands.

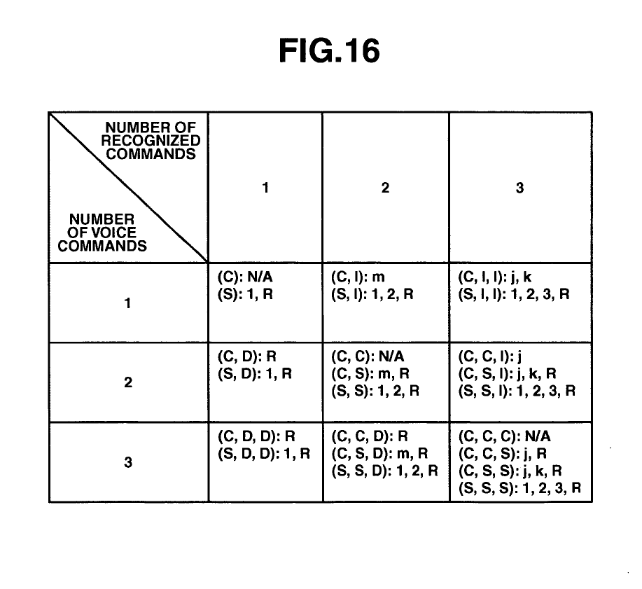

FIG. 16 is a diagram showing examples of operations of pressing the physical key in specifying an incorrect portion in a recognition result with respect to the combinations shown in FIG. 14. As the section in which a pair of (the number of voice commands, the number of recognized commands) is (1, 1), (1, 2), (2, 1), and (2, 2) is exactly the same as in FIG. 7, explanation on this section will not be repeated here. Additionally, although the other pairs are also the same as in the case of FIG. 7, numeric keys j and k in FIG. 16 are the same as those in FIG. 15 wherein j and k take the values between 1 and 3 and j and k take different values (j!=k).

### Third Embodiment

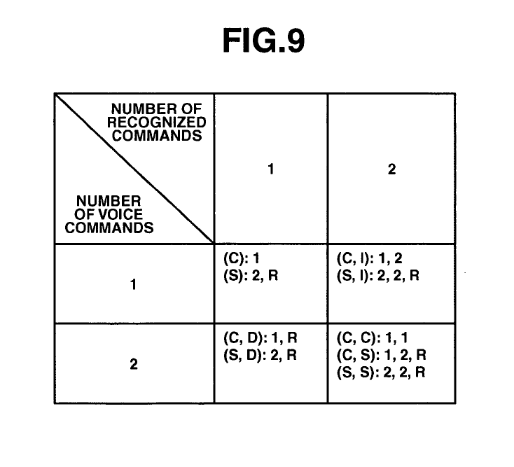

In the first and second embodiments, either a correct portion or an incorrect portion in a recognition result for the combinations shown in FIG. 3 or FIG. 14 is specified. However, it is possible to specify each of the results as correct or incorrect for all of the recognition results. There are various ways of specifying each of the results as correct or incorrect. The following example describes a case where numeric key “1” is pressed when the result is correct and numeric key “2” is pressed when the result is incorrect. FIG. 9 is a diagram showing examples of operations of pressing the physical key in specifying each of the recognition results as correct or incorrect with respect to the combinations shown in FIG. 3.

“(C): 1” indicates that numeric key “1” is pressed in a case where both the number of voice commands and the number of recognized commands are one, and the result is correct. “1” means that the recognized command output as a recognition result is “correct”. Similarly, “(C, C):1, 1” indicates that in a case where both the number of voice commands and the number of recognized commands are two, and both results are correct, numeric key “1” is pressed twice as the first and second recognized commands are “both correct”.

Additionally, “(S): 2, R” corresponds to a case where both the number of voice commands and the number of recognition commands are one, and the result is incorrect (S). In this case, as the result is incorrect, numeric key “2” is pressed, and then, re-speak R is conducted to re-utter a misrecognized portion by voice. Similarly, as there are no correct results in “(S, D): 2, R”, “(S, I): 2, 2, R”, and “(S, S): 2, 2, R”, numeric key “2” is pressed as many times as the number of misrecognitions in a recognition result, and then, re-speak R is conducted.

Moreover, “(C, D): 1, R” corresponds to a case where the number of voice commands is two, the number of recognized commands is one, and one result is correct and the other results in a deletion error (D). In this case, as the output result as a recognized command is correct, numeric key “1” is pressed, and then, re-speak R is conducted to input a command which has resulted in a deletion error.

Furthermore, “(C, I): 1, 2” corresponds to a case where the number of voice commands is one, the number of recognized commands is two, one of which is correct and the other results in an insertion error (I). In this case, as the portion corresponding to C is correct, numeric key “1” is pressed, and as the portion corresponding to the insertion error is incorrect, numeric key “2” is pressed. It should be appreciated that the order of pressing numeric keys “1” and “2” is to be in accordance with the order of the output of the results. That is, in a case where the first result is correct (C) and the second result is an insertion error (I), keys are depressed in the order of “1” and “2”. In a case where the first result is an insertion error (I) and the second result is correct (C), then keys are pressed in the order of “2” and “1”. Similarly, for “(C, S): 1, 2, R”, numeric key “1” is pressed for a correct portion and numeric key “2” is pressed for a substitution error portion, and then, re-speak R is conducted to input a command that has resulted in the substitution error.

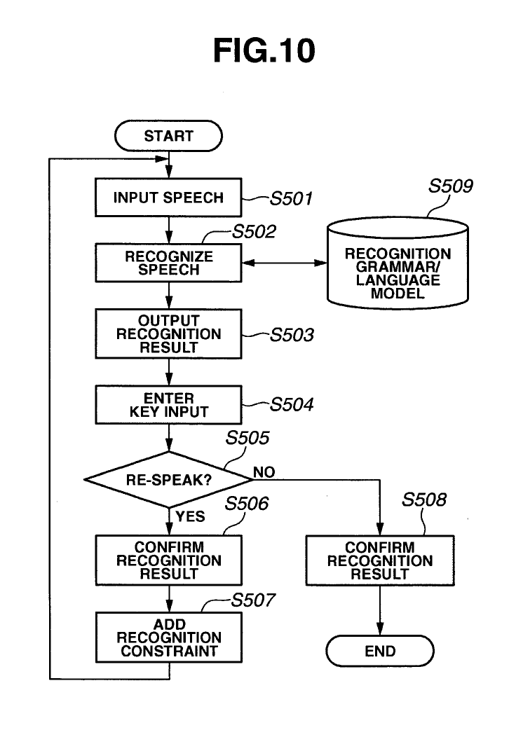

FIG. 10 is a flowchart showing the process of a speech recognition result correction method in which each of the recognition results is specified as correct or incorrect. In FIG. 10, as steps S501 to S503 are the same as steps S301 to S303, and a recognition grammar/language model S509 is the same as the recognition grammar/language model S310, explanation on these steps will not be repeated here. In step S504, the key input for specifying whether each of the recognition results is correct or incorrect is entered. Next, in step S505, it is determined whether re-speak is conducted. If re-speak is to be conducted, that is, in the cases of (S), (C, D) , (S, D), (S, I), (C, S), and (S, S), the recognition result of a correct portion is confirmed in step S506. For example, in the case of (C, D), it can be understood that the user has input two commands, one of which has been correctly recognized and the other has resulted in a deletion error. That is, it can be expected that one command is spoken in the re-speak of such cases. Therefore, as in step S307 in the first embodiment, a constraint can be added in performing speech recognition of the re-speak. Step S507 is a process for placing such a recognition constraint. To be more precise, the constraint is placed on the recognition grammar/language model S509 when the speech of the re-speak is recognized. The process then returns to step S501 (or, it is also possible to conduct a process in which only the results among the speech recognition result of the re-speak that satisfy the constraint are output in step S503). If a constraint cannot be placed, the recognition constraint addition process is not conducted. It will be appreciated that the determination as to whether re-speak is conducted should be made in the same way as in the above-described embodiments.

In a case where it is determined in step S505 that re-speak is not conducted, that is, in the cases of (C), (C, I), and (C, C) (or, in cases where time has run out for (S), (C, D), (S, D), (S, I), (C, S), and (S, S)), the correct portion is confirmed in step S508 for the results in which a correct portion can be confirmed. The process then ends.

In the third embodiment, a method in which, after all of the recognition results have been output, the specification of whether each of the results is correct or incorrect is made has been described. The result can be output one by one inunits of recognition and can be consecutively specified whether each result is correct or incorrect.

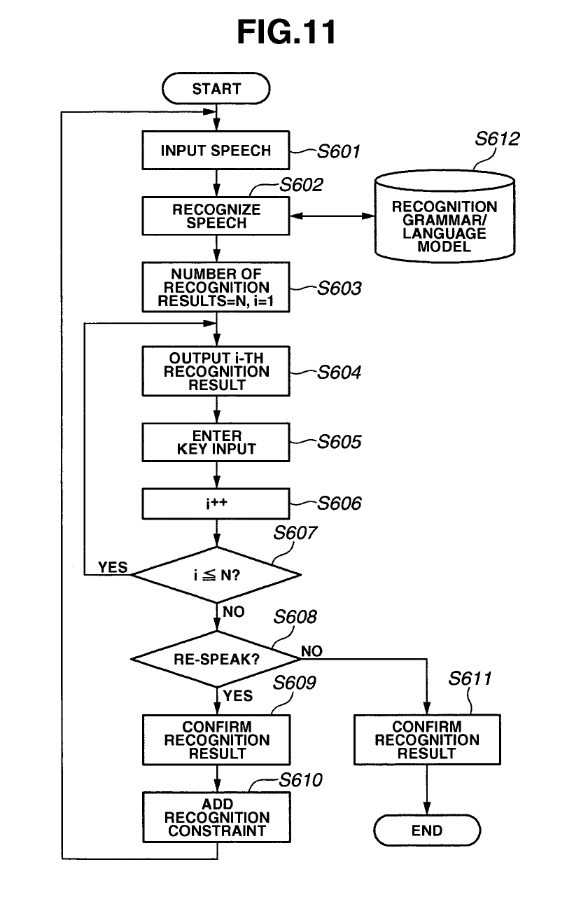

FIG. 11 is a flowchart showing the process of a speech recognition result correction method in which it is sequentially specified whether a recognition result in each recognition unit is correct or incorrect. In this flowchart, as steps S601, S602, S612, and S608 to S611 are the same as steps S501, S502, S509, and S505 to S508, respectively, explanation on these steps will not be repeated here. In step S603, the number of results in units of recognition is set as N based on the recognition results obtained in step S602, and a counter i is set to 1. Next, in step S604, the i-th recognition result is output. In step S605, key input (either “1” when the result is correct or “2” when the result is incorrect) is entered. In step S606, the counter i is incremented by 1. In step S607, it is determined whether i is equal to or less than N. In a case where i is equal to or less than N, the process returns to step S604. In a case where i is greater than N, the process proceeds to step S608.

In the third embodiment, combinations of correct and incorrect results in a case where up to two commands can simultaneously be recognized with respect to one utterance have been described. In the same way as in the first and second embodiments, the third embodiment can be applied to a given number of commands.

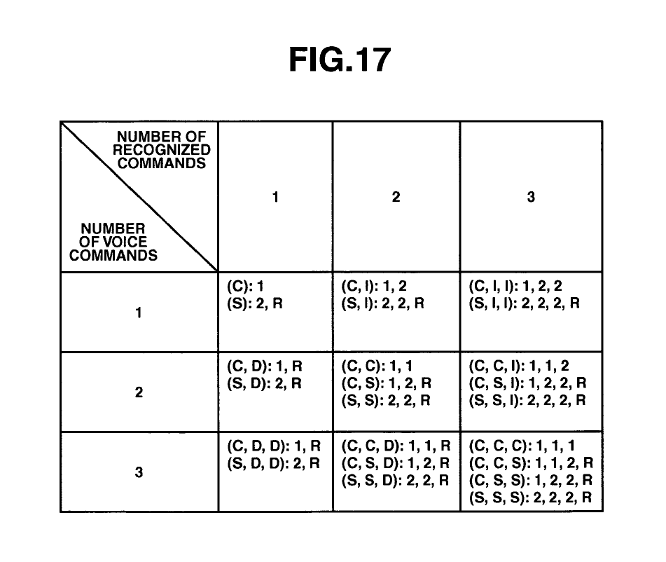

FIG. 17 is a diagram showing examples of operations of pressing the physical key in specifying whether each of the recognition results is correct or incorrect for the combinations shown in FIG. 14. The section in which a pair of (the number of voice commands, the number of recognized commands) is (1, 1), (1, 2), (2, 1), and (2, 2) is the same as in FIG. 9. The rest of the pairs are also the same as in FIG. 9.

### Fourth Embodiment

In the second embodiment, an incorrect portion in a recognition result is specified for the combinations shown in FIG. 3 or FIG. 14. For example, in the case of “1, R” in FIG. 7, although it can be determined that one of the recognition results is misrecognized, it cannot be determined whether the number of input voice commands is one or two. That is, it is not distinguishable whether the combination of the recognition error is (S) or (S, D). Similarly, in the case of “1, 2, R”, it is not distinguishable between (S, I) and (S, S). Therefore, in such cases, constraints cannot be placed when recognizing the re-speak. Accordingly, it is possible that the same misrecognition will occur, and the correct result will be difficult to obtain.

The fourth embodiment is provided in view of this problem. In addition to specifying an incorrect portion in a recognition result, by directly and indirectly specifying the type of error, constraints can be placed on all combinations in recognizing the re-speak.

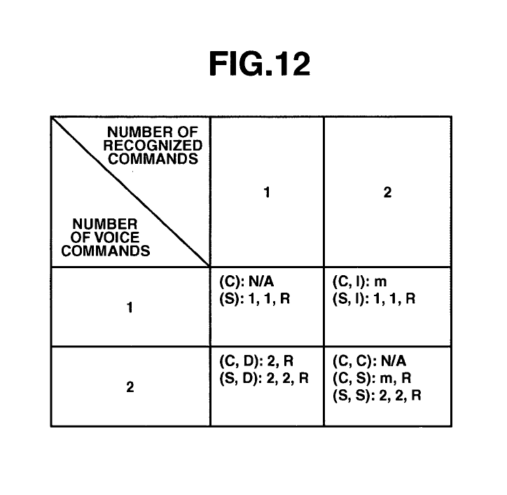

At this point, an application of the following rule for pressing the physical key is considered. That is, in a case where all of the recognized commands corresponding to the voice commands are incorrectly recognized, a numeric key corresponding to the number of spoken words is pressed twice (rule 1). In a case where there is no misrecognition but there is a lack of a correct result, a numeric key corresponding to the position to be added is pressed (rule 2). In a case where all or a part of the voice commands have been recognized but the result also includes misrecognitions, a numeric key corresponding to the position of the recognized command in the incorrect portion is pressed (rule 3). By applying these rules to the combinations shown in FIG. 3, examples of operations shown in FIG. 12 are obtained. N/A indicates that as all of the results are correct and there are no misrecognitions, an incorrect portion does not have to be specified. In this case, rule 1 is applied to the examples of (S), (S, D), (S, I), and (S, S), rule 2 to the example of (C, D), and rule 3 to the examples of (C, I) and (C, S). Additionally, (C, I): m indicates that in a case where the first recognized command results in an insertion error, numeric key “1” is pressed (m=1), and in a case where the second recognized command results in an insertion error, numeric key “2” is pressed (m=2). Similarly, (C, S) m, R indicates that in a case where the first recognized command results in a substitution error, numeric key “1” is pressed (m=1), and in a case where the second recognized command results in a substitution error, numeric key “2” (m=2) is pressed, and then re-speak is conducted. In addition to specifying an incorrect portion, by applying such key pressing operations, the pattern of button pressing operations differs for all combinations with the same number of recognized commands. Accordingly, unique identification of the corresponding error pattern in FIG. 12 can be performed. That is, by using the button pressing operations shown in FIG. 12, an incorrect portion and a type of error (substitution, insertion, or deletion) can be directly or indirectly specified. By using such a specification method, a constraint can be placed on the recognition when there is re-speak, so that the possibility of correct recognition of the re-speak can be improved.

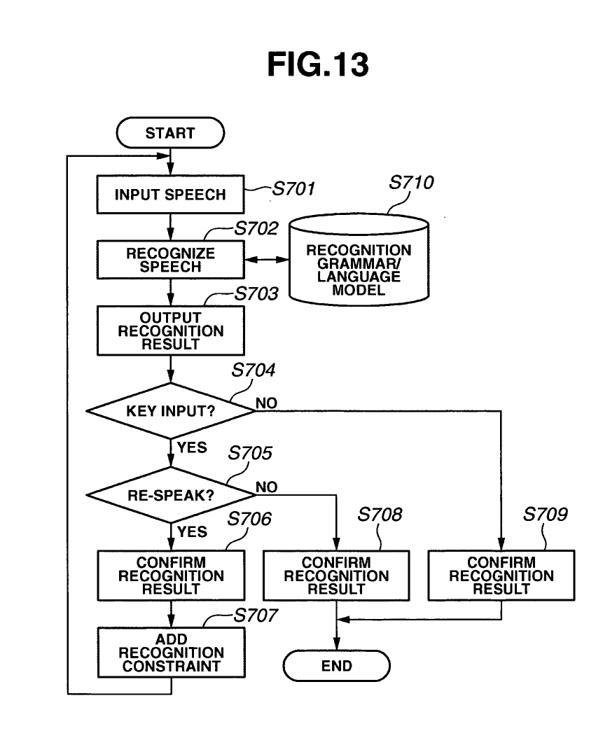

FIG. 13 is a flowchart showing the process of a speech recognition result correction method in which an incorrect portion and a type of error in a recognition result are specified. In this flowchart, as steps S701 to S703 are the same as steps S301 to S303, and a recognition grammar/language model S710 is the same as the recognition grammar/language model S310, explanations on these steps will not be repeated here. In step S704, it is determined whether the key input to specify an incorrect portion and a type of error is entered. In a case where the key input is entered, or in the cases other than (C) and (C, C), it is determined in step S705 whether re-speak is conducted. If it is determined that there is re-speak, or in the cases of (S), (C, D), (S, D), (S, I), (C, S), and (S, S), a recognition result is confirmed in cases where the correct portion can be confirmed, or for C in (C, D) and (C, S), in step S706. The determination process is not conducted for cases other than these. In this process, it is possible to confirm that the number of voice commands in the re-speak is one in the cases of (S), (C, D), (S, I), and (C, S), and two in the cases of (S, D) and (S, S). Therefore, in performing the speech recognition of the re-speak, it is possible to add constraints such as these. Step S707 is a process that makes such addition of the recognition constraint. To be more precise, in recognizing speech in the re-speak, a constraint is placed on the recognition grammar/language model S710. The process then returns to step S701. Alternatively, it is possible to conduct a process in which only the result among the speech recognition results of the re-speak satisfying the constraint is output in step S703. It will be appreciated that the determination as to whether key input is entered or whether re-speak is conducted can be made in the same way as in the above-described embodiments. In a case where it is determined in step S705 that there is no re-speak, or in the case of (C, I), (or, in a case where time has run out in (S), (C, D), (S, D), (S, I), (C, S), and (S, S)), a correct portion is confirmed in step S708 for those of which the correct portion can be confirmed. The process then ends. Additionally, in a case where there is no key input in step S704, that is, in the cases of (C) and (C, C), the recognition result is confirmed to be correct in step S709. The process then ends.

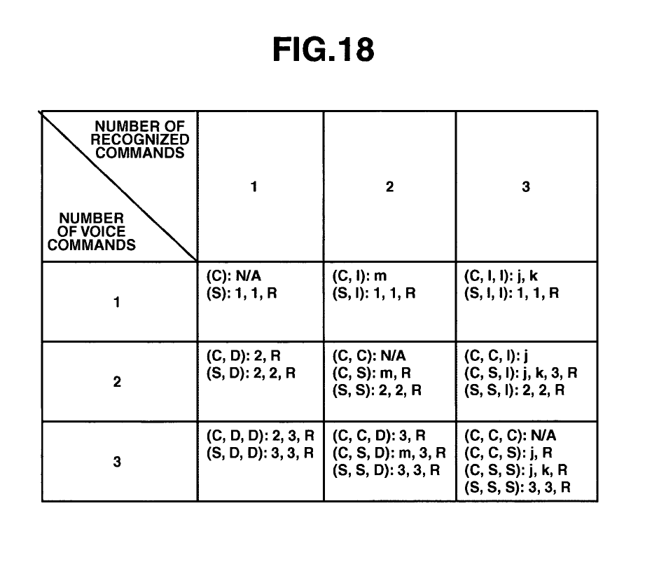

In the fourth embodiment, all of combinations of correct and incorrect results in a case where up to two commands can simultaneously be recognized with respect to one utterance have been described. In the same way as in the first to third embodiments, the fourth embodiment can be applied to a given number of commands. FIG. 18 is a diagram showing examples of operations of pressing the physical key in specifying an incorrect portion and a type of error in a recognition result for the combinations shown in FIG. 14. As the section in which a pair of (the number of voice commands, the number of recognition commands) is (1, 1), (1, 2), (2, 1), and (2, 2) is the same as in FIG. 12, explanations on this section will not be repeated here. Additionally, the rest of the pairs are key pressing patterns in which the above-described rules 1 to 3 have been applied. Although it is possible to apply rule 3 to cases where a correct result and two types of errors are mixed, or, in the cases of (C, S, D) and (C, S, I), ((C, D, I), which is another case that can be considered, is assumed to be (C, S)), the following modified rule of rule 3 is used to uniquely identify an error pattern in FIG. 18. That is, in a case where correct and incorrect portions are mixed in the voice command, and the number of recognized commands is less than the number of voice commands, numeric key “3” is pressed after a numeric key corresponding to the position of the recognized command in the incorrect portion is pressed (rule 3-1). Additionally, in a case where correct and incorrect portions are mixed in the voice command, and the number of recognized commands is greater than the number of the voice commands, numeric key “3” is pressed after numeric key corresponding to the position of the recognized command in the incorrect portion is pressed (rule 3-2). j and k in FIG. 18 are the same as those in FIG. 15, taking values between 1 to 3 and j and k taking different values (j!=k).

It will be apparent to those skilled in the art that the present invention can be achieved by providing a storage medium which stores program code (software) which implements the functions of the above-described embodiments to a system or an apparatus, and by the computer (CPU or micro-processing unit (MPU)) of such a system or apparatus reading and executing the program code stored in the storage medium.

In this case, the program code itself that is read from the storage medium implements the functions of the above-described embodiments, and the storage medium which stores such program code constitutes the present invention.

Examples of the storage medium for storing the program code include a flexible disk, a hard disk, an optical disk, a magneto-optical disk, a CD-ROM, a CD-recordable (CD-R), a magnetic tape, a nonvolatile memory card, and a ROM.

Additionally, it will be apparent to those skilled in the art that by executing the program code read by the computer, besides the functions of the above-described embodiments being implemented, the operating system (OS) running on the computer may conduct a part or all of the actual process based on the instructions of the program code, by which the above-described embodiments are implemented.

Furthermore, it will be apparent to those skilled in the art that the case in which, after the program code read from the storage medium is written in memory equipped in a function extension board inserted in a computer or a function extension unit connected to a computer, a CPU equipped in the function extension board or the function extension unit may conduct a part or all of the process according to the instructions of the program code, by which the functions of the above-described embodiments are implemented.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-045618 filed Feb. 22, 2005, which is hereby incorporated by reference herein in its entirety.

What is claimed is:

1. A speech recognition method, comprising:
a receiving step of receiving speech information;
a speech recognition step of recognizing the speech information received in the receiving step to obtain a recognition result;
an outputting step of outputting the recognition result obtained in the speech recognition step; and
a correcting step of correcting the recognition result output by the outputting step based on re-speak received after accepting a specification of a correct portion in the recognition result via at least one physical key.

2. The speech recognition method according to claim 1, wherein the at least one physical key is a numeric key.

3. The speech recognition method according to claim 1, wherein the correcting step includes a step of specifying the correct portion in order of the recognition result.

4. The speech recognition method according to claim 1, further comprising a recognition constraint addition step of placing a constraint on recognition of a respoken speech based on a result of the correcting step.

5. The speech recognition method according to claim 1, wherein the outputting step includes a step of outputting the recognition result by voice.

6. The speech recognition method according to claim 5, wherein the outputting step includes a step of outputting the recognition result by voice including an auditory signal for indicating separation between units of recognition.

7. A computer-readable medium storing computer-executable instructions for causing a computer to execute the speech recognition method according to claim 1.

8. A speech recognition method, comprising:
a receiving step of receiving speech information;
a speech recognition step of recognizing the speech information received in the receiving step to obtain a recognition result:
an outputting step of outputting the recognition result obtained in the speech recognition step; and
a correcting step of correcting the recognition result output by the outputting step based on re-speak received after accepting a specification of an incorrect portion in the recognition result via at least one physical key.

9. A computer-readable medium storing computer-executable instructions for causing a computer to execute the speech recognition method according to claim 8.

10. A speech recognition method, comprising:
a receiving step of receiving speech information;
a speech recognition step of recognizing the speech information received in the receiving step to obtain a recognition result:
an outputting step of outputting the recognition result obtained in the speech recognition step; and
a correcting step of correcting the recognition result output by the outputting step after accepting a specification of whether the recognition result is correct or incorrect via at least one physical key.

11. The speech recognition method according to claim 10, wherein the outputting step includes a step of sequentially outputting the recognition result in units of recognition, and wherein the correcting step includes a step of specifying whether the recognition result in units of recognition is correct or incorrect via the at least one physical key.

12. The speech recognition method according to claim 10, further comprising a step of conducting re-speak for a misrecognition by voice after specifying with the at least one physical key.

13. A computer-readable medium storing computer-executable instructions for causing a computer to execute the speech recognition method according to claim 10.

14. A speech recognition method, comprising:
a receiving step of receiving speech information;
a speech recognition step of recognizing the speech information received in the receiving step to obtain a recognition result:
an outputting step of outputting the recognition result obtained in the speech recognition step; and
a correcting step of correcting the recognition result output by the outputting step after receiving a specification of an incorrect portion and a type of error in the recognition result via at least one physical key.

15. The speech recognition method according to claim 14, wherein the type of error includes a substitution error, an insertion error, and a deletion error.

16. The speech recognition method according to claim 14, further comprising a specifying step of simultaneously specifying the incorrect portion and the type of error in one continuous operation.

17. A computer-readable medium storing computer-executable instructions for causing a computer to execute the speech recognition method according to claim 14.

18. A speech recognition apparatus, comprising:
a receiving unit configured to receive speech information;
a speech recognition unit configured to recognize the speech information received by the receiving unit to obtain a recognition result;
an output unit configured to output the recognition result obtained by the speech recognition unit; and
a correction unit configured to correct the recognition result output by the output unit based on re-speak received after accepting a specification of a correct portion in the recognition result via at least one physical key.

19. The speech recognition apparatus according to claim 18, wherein the at least one physical key is a numeric key.

20. The speech recognition apparatus according to claim 18, wherein the correction unit is configured to specify the correct portion in order of the recognition result.

21. The speech recognition apparatus according to claim 18, further comprising a recognition constraint addition unit configured to place a constraint on recognition of a respoken speech based on a result obtained by the correction unit.

22. A speech recognition apparatus, comprising:
a receiving unit configured to receive speech information;
a speech recognition unit configured to recognize the speech information received by the receiving unit to obtain a recognition result;
an output unit configured to output the recognition result obtained by the speech recognition unit; and
a correction unit configured to correct the recognition result output by the output unit based on re-speak received after accepting a specification of an incorrect portion in the recognition result via at least one physical key.

23. A speech recognition apparatus, comprising:
a receiving unit configured to receive speech information;
a speech recognition unit configured to recognize the speech information received by the receiving unit to obtain a recognition result;
an output unit configured to output the recognition result obtained by the speech recognition unit; and
a correction unit configured to correct the recognition result output by the output unit by accepting a specification of whether the recognition result is correct or incorrect via at least one physical key.

24. A speech recognition apparatus, comprising:
a receiving unit configured to receive speech information;
a speech recognition unit configured to recognize the speech information received by the receiving unit to obtain a recognition result;
an output unit configured to output the recognition result obtained by the speech recognition unit; and
a correction unit configured to correct the recognition result output by the output unit by accepting a specification of an incorrect portion and a type of error in the recognition result via at least one physical key.
